(19) United States
(12) Patent Application Publication
(10) Pub. No.: US 2025/0230665 A1
(43) Pub. Date: Jul. 17, 2025

(54) FLOORING SYSTEM AND METHOD FOR MANUFACTURING THE SAME

(71) Applicant: Versatrim LLC, Henderson, NC (US)

(72) Inventors: Aleftin Martens, Verl (DE); Markus Schalkamp, Henderson, NC (US)

(21) Appl. No.: 18/929,133

(22) Filed: Oct. 28, 2024

Related U.S. Application Data
(63) Continuation-in-part of application No. 18/414,845, filed on Jan. 17, 2024.

(30) Foreign Application Priority Data
Jan. 17, 2024 (DE) 102024101226.9

(51) Int. Cl. E04F 11/16; B23P 21/00

(52) U.S. Cl. CPC E04F 11/163; B23P 21/00

(57) ABSTRACT

A flooring panel comprising a first end, a second end opposite the first end, and an axis extending between the first end and the second end. A tread portion extends between the first and second ends, the tread portion configured to be coupled to a tread of a stair. A curved cap is integrally formed with the tread portion and extends between the first end and the second end, the curved cap configured to be coupled to an edge of the stair. A plurality of grooves is formed in an inner surface of the curved cap, the plurality of grooves extending parallel to the axis of the tread portion, the plurality of grooves extending along a majority of inner surface of the curved cap. A cover member is adhesively coupled to the inner surface and covering the plurality of grooves.

### CROSS-REFERENCE TO RELATED APPLICATIONS

This application is a continuation-in-part of co-pending U.S. patent application Ser. No. 18/414,845 filed on Jan. 17, 2024, the entire content of which is incorporated herein by reference. This application also claims priority to German Patent Application No. DE 10 2024 101 226.9 filed on Jan. 17, 2024, the entire contents of which is incorporated herein by reference.

### FIELD OF THE INVENTION

The present invention relates to a flooring system for use on stairs and a method for manufacturing the flooring system.

### SUMMARY OF THE INVENTION

The present invention provides, in one aspect, a flooring panel comprising a first end, a second end opposite the first end, and an axis extending between the first end and the second end. A tread portion extends between the first and second ends, the tread portion configured to be coupled to a tread of a stair. A curved cap is integrally formed with the tread portion and extends between the first end and the second end, the curved cap configured to be coupled to an edge of the stair. A plurality of grooves is formed in an inner surface of the curved cap, the plurality of grooves extending parallel to the axis of the tread portion, the plurality of grooves extending along a majority of inner surface of the curved cap.

The present invention provides, in one aspect, a method of manufacturing a nose flooring panel, where the method includes providing a flooring panel having a first end, a second end opposite the first end, and an axis extending between the first end and the second end, supporting a first portion of the flooring panel on a flooring panel forming machine, the forming machine configured to move the flooring panel along an imaginary plane extending from a first end to a second end of the forming machine, forming a recessed section in a second portion of the flooring panel such that the first portion has a first thickness and the second portion has a second thickness that is less than the first thickness, and cutting a plurality of grooves in the recessed section of the flooring panel, the plurality of grooves extending parallel to the axis. The method further includes applying adhesive to the plurality of grooves, heating the second portion of the flooring panel, bending the second portion of the flooring panel into a cap while maintaining the flat shape of the first portion of the flooring panel to form a tread, and cooling the second portion to cure the adhesive.

The present invention provides, in one aspect, a flooring panel forming machine for making nose flooring panels, where the machine comprises a material removal stage configured form a recessed section in a flooring panel such that the flooring panel includes a first portion with a first thickness and a second portion with a second thickness that is less than the first thickness, the material removal stage further configured to cut a plurality of grooves within the second portion of the flooring panel, the plurality of grooves extending parallel to one another from a first end to a second end of the flooring panel. The machine further comprises a heating stage configured to melt an adhesive and apply the melted adhesive to the plurality of grooves, a bending stage configured to form the second portion of the flooring panel into a cap while maintaining the flat shape of the first portion of the flooring panel to form a tread, and a cooling stage configured to cool the second portion of the flooring panel to cure the adhesive, wherein the machine includes a conveyor system configured to continuously move the flooring panel through the stages of the machine to form a nose flooring panel.

The present invention provides, in one aspect, a flooring panel comprising a first end, a second end opposite the first end, and an axis extending between the first end and the second end. A tread portion extends between the first and second ends, the tread portion configured to be coupled to a tread of a stair. A polygonal cap is integrally formed with the tread portion and extending between the first end and the second end, the polygonal cap configured to be coupled to an edge of the stair. The polygonal cap includes a first wall extending from the tread portion, a second wall extending from the first wall, a first corner positioned between the tread portion and the first wall, the first corner including a first plurality of grooves extending parallel to the axis of the tread portion between the first end and the second end, and a second corner extending between the first wall and the second wall, the second corner including a second plurality of grooves parallel to the axis of the tread portion between the first end and the second end.

Other features and aspects of the invention will become apparent by consideration of the following detailed description and accompanying drawings.

### BRIEF DESCRIPTION OF THE DRAWINGS

FIG. 1 illustrates a perspective view of a flooring system according to an embodiment and coupled to a staircase.

FIG. 2A illustrates a top perspective view of a pre-assembled nose-tread assembly of a flooring system according to another embodiment.

FIG. 2B illustrates a bottom perspective view of the pre-assembled nose-tread assembly of the flooring system of FIG. 2A.

FIG. 2C illustrates a perspective view of a pre-assembled nose-tread assembly of a flooring system according to another embodiment.

FIG. 3 illustrates a perspective view of the pre-assembled nose-tread assembly of the flooring system of FIG. 2A with a pair of end caps.

FIG. 4 illustrates a perspective view of the pre-assembled nose-tread assembly of the flooring system of FIG. 2A with another pair of end caps.

FIG. 5 illustrates a perspective view of a flooring system according to another embodiment and coupled to a staircase.

FIG. 6A illustrates a top perspective view of a pre-assembled nose-tread assembly of a flooring system according to another embodiment.

FIG. 6B illustrates a bottom perspective view of the pre-assembled nose-tread assembly of the flooring system of FIG. 6A.

FIG. 6C illustrates a perspective view of a pre-assembled nose-tread assembly of a flooring system according to another embodiment.

FIG. 7 illustrates a perspective view of the pre-assembled nose-tread assembly of the flooring system of FIG. 2A with a pair of end caps.

FIG. 8 illustrates a perspective view of the pre-assembled nose-tread assembly of the flooring system of FIG. 2A with another pair of end caps.

FIG. 9 is a cross-sectional view of the flooring system of FIG. 1 along the lines 9-9 of FIG. 1.

FIG. 10 is a cross-sectional view of the flooring system of FIG. 5 along the lines 10-10 of FIG. 1.

FIG. 11 illustrates a floor panel forming machine for forming a portion of the pre-assembled nose-tread assembly of FIGS. 1-4 and 9.

FIG. 12A illustrates a method step for forming a portion of the pre-assembled nose-tread assembly of FIGS. 1-4 and 9.

FIG. 12B illustrates another method step for forming a portion of the pre-assembled nose-tread assembly of FIGS. 1-4.

FIG. 12C illustrates another method step for forming a portion of the pre-assembled nose-tread assembly of FIGS. 1-4 and 9.

FIG. 12D illustrates another method step for forming a portion of the pre-assembled nose-tread assembly of FIGS. 1-4 and 9.

FIG. 13 illustrates a floor panel forming machine for forming a portion of the pre-assembled nose-tread assembly of FIGS. 5-8 and 10.

FIG. 14A illustrates a method step for forming a portion of the pre-assembled nose-tread assembly of FIGS. 5-8 and 10.

FIG. 14B illustrates another method step for forming a portion of the pre-assembled nose-tread assembly of FIGS. 5-8 and 10.

FIG. 14C is a detailed view of a portion of FIG. 14B.

FIG. 14D illustrates another method step for forming a portion of the pre-assembled nose-tread assembly of FIGS. 5-8 and 10.

FIG. 14E illustrates another method step for forming a portion of the pre-assembled nose-tread assembly of FIGS. 5-8 and 10.

FIG. 14F illustrates another method step for forming a portion of the pre-assembled nose-tread assembly of FIGS. 5-8 and 10.

FIG. 15 is a flow chart for a method of forming a nose flooring panel with a polygonal cap.

FIG. 16 is a flow chart for a method of forming a nose flooring panel with a curved cap.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

### Flooring System

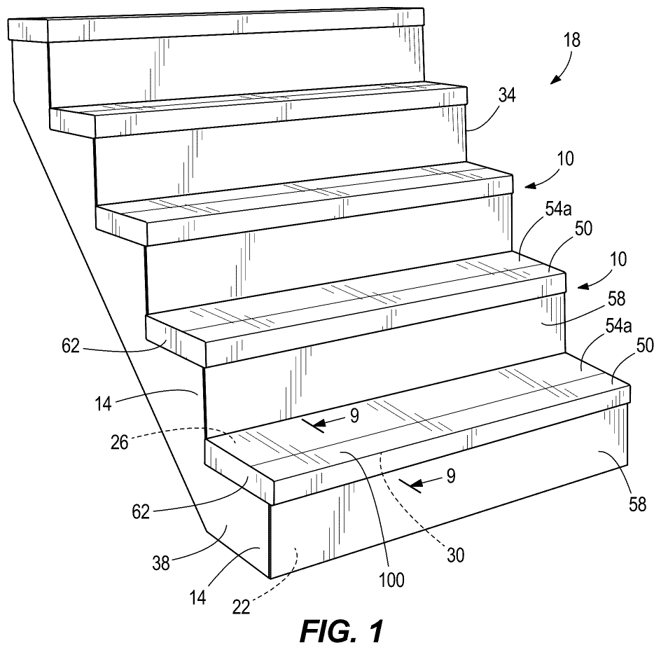

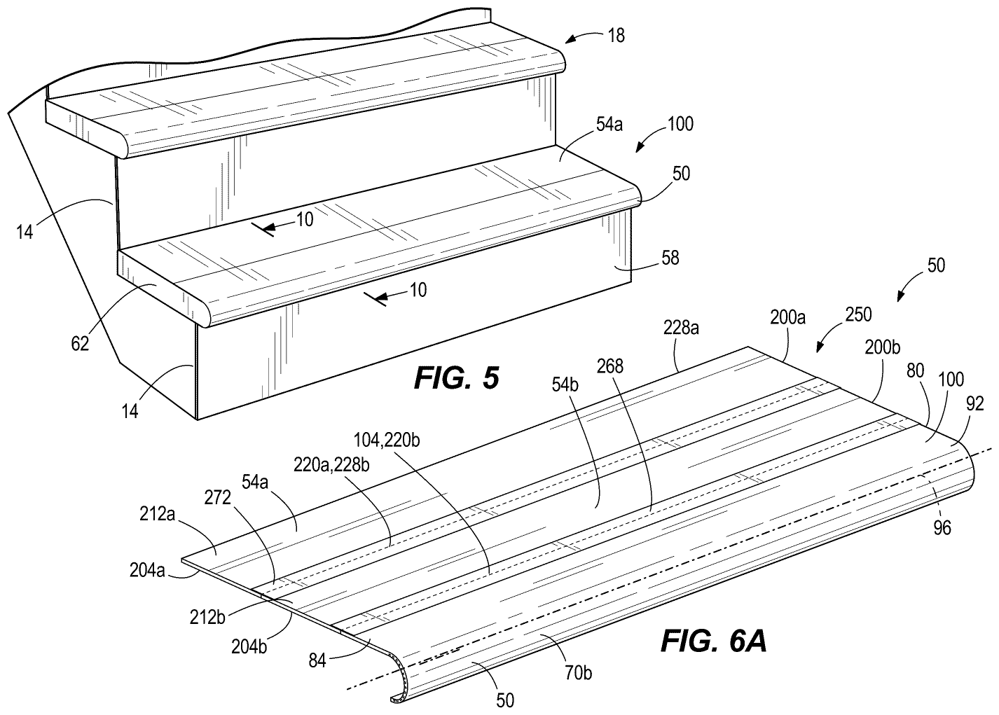

Disclosed herein is a flooring system including various floor panels (such as aesthetically pleasing wood grain panels) to cover the underlying stair structure. With reference to FIGS. 1 and 5, a flooring system 10 is coupled to a stair 14 of a staircase 18. Each stair 14 includes a riser 22 and a tread 26, which meet to form a stair edge 30. The stairs 14 are coupled to one another by a first side wall 34 and a second side wall 38 opposite the first side wall 34. The flooring system 10 may include one or more of a nose flooring panel 50 (e.g., a first flooring panel) coupled to the stair edge 30, a tread flooring panel 54 (e.g., a second flooring panel) coupled to the nose flooring panel 50 and the tread 26 of the stair 14, a riser flooring panel 58 (e.g., a third flooring panel) coupled riser 22 of the stair 14, and at least one end cap 62 coupled to the nose flooring panel 50 (and in some cases the tread flooring panel 54). The flooring system 10 is useable on a single stair 14 or a staircase having more than one stair 14, as illustrated. In the case of a staircase 18 having multiple stairs 14, for example, as shown in FIGS. 1 and 5, the staircase 18 includes multiple the flooring systems 10, one for each stair 14.

The flooring system 10 of FIGS. 1-4 and 9 includes nose flooring panels 50 having a first cap 70a or nose configuration. As shown, the cap 70a of the nose flooring panels 50 has a polygonal shape (e.g., a square cap or nose). The flooring system 10 of FIGS. 5-8 and 10 includes nose flooring panels 50 having a second cap 70b or nose configuration. As shown, the cap 70b or the nose flooring panels 50 has a curved or arcuate shape. In other words, the curved cap 70b has a circular or partial circular cross-section. In the illustrated embodiment, the curved cap 70b forms a half circle cross-section. The flooring systems 10 include generally the same features and therefore like reference numerals are used for like structure and the differences are explicitly discussed.

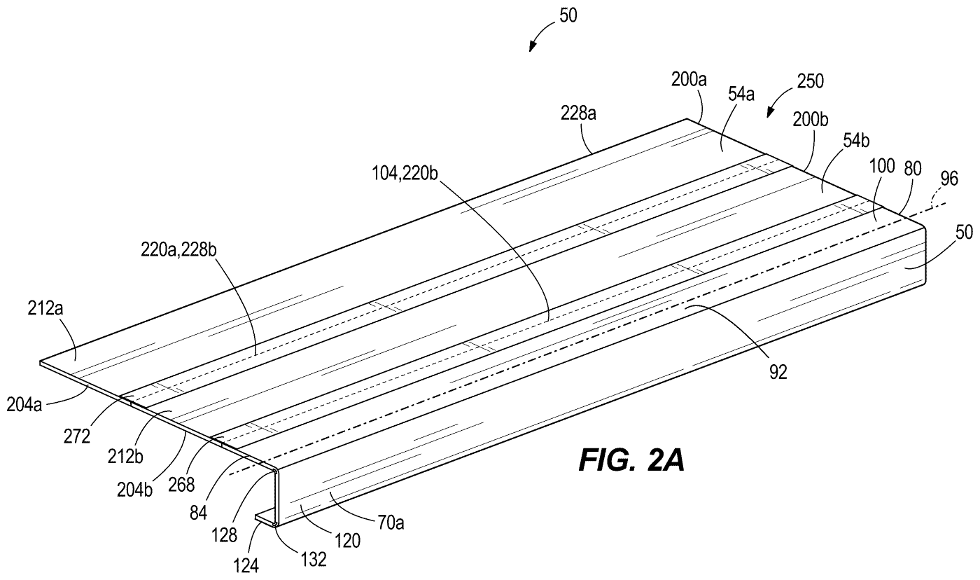

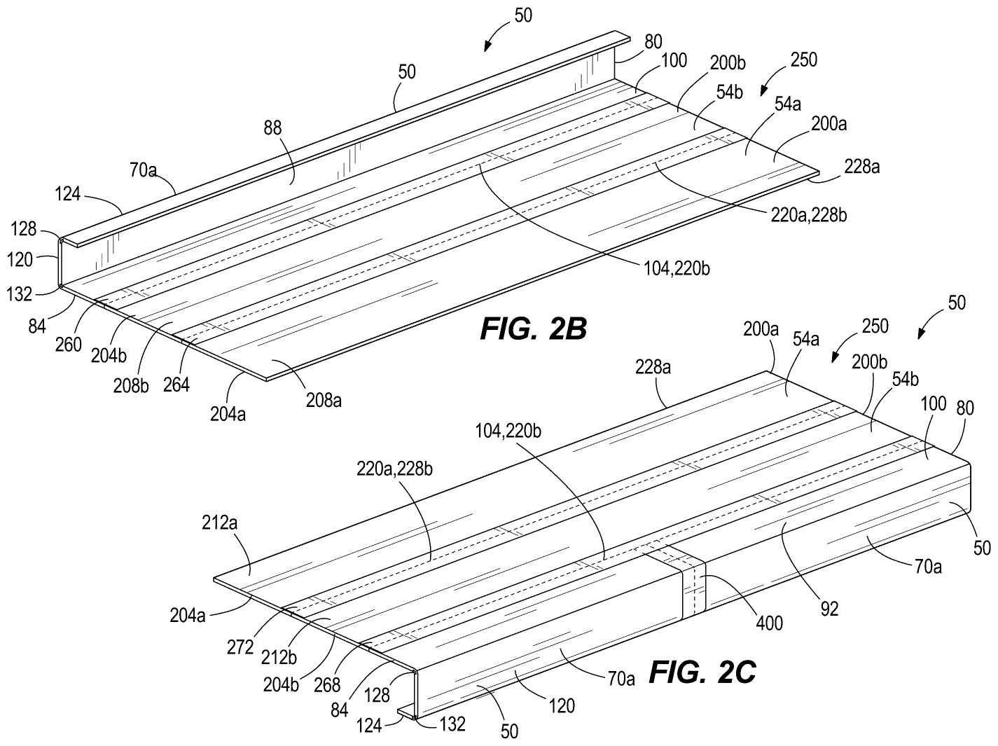

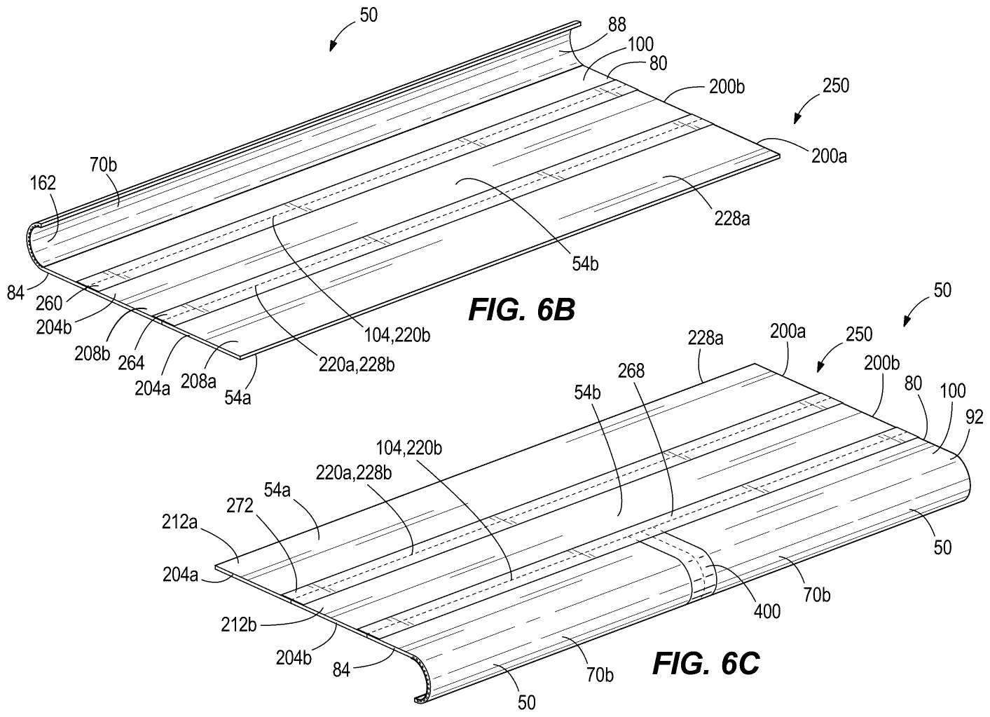

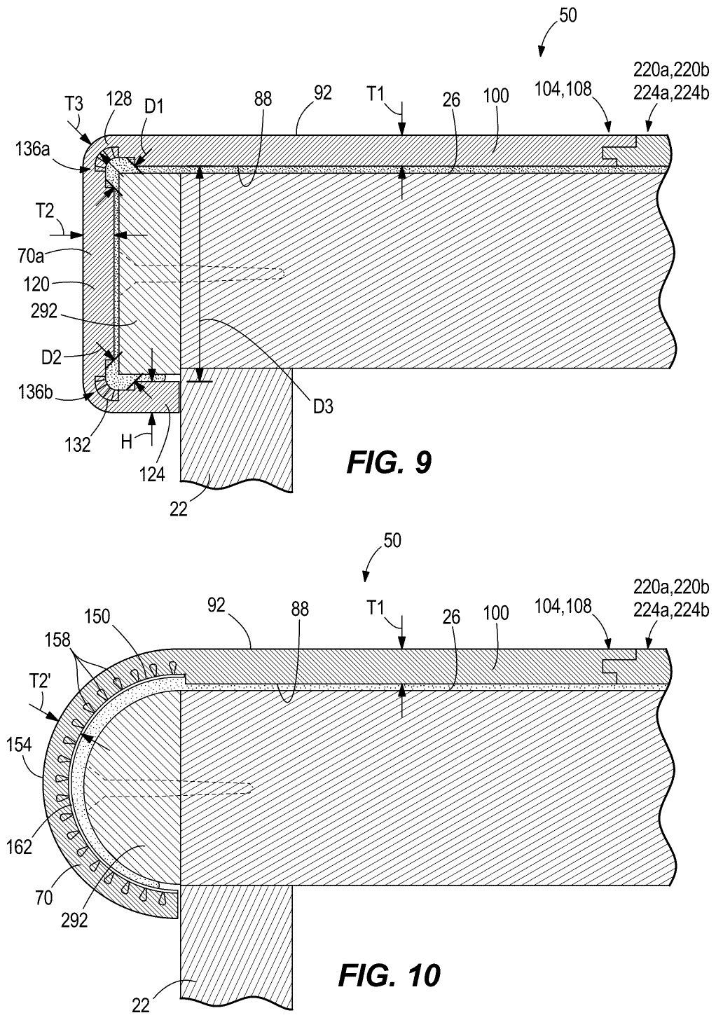

As noted above and shown in FIGS. 1 and 5, each of the nose flooring panels 50 is configured to be coupled to stair edge 30. With respect to FIGS. 2A-2C and 6A-6C, the nose flooring panel 50 includes a first end 80, a second end 84 opposite the first end 80, an inside 88 (e.g., first side), an outside 92 (e.g., second side) opposite the inside 88, and an axis 96 extending between the first end 80 and the second end 84. As described herein, the axis 96 extends along the length (i.e., the longer direction) of the nose flooring panel 50. The nose flooring panel 50 has a tread portion 100 (e.g., a first portion), the cap 70 (e.g., nose or bent edge) extending from the tread portion 100, and a first coupling edge 104 opposite the cap 70. Each of the tread portion 100, the cap 70, and the first coupling edge 104 extend between the first end 80 and the second end 84. The tread portion 100 has a first thickness T1 (FIGS. 9 and 10) measured between the inside 88 and the outside 92 of the nose flooring panel 50. The coupling edge 104 includes a first interface 108, which is shown as a groove in this embodiment.

### Nose Flooring Panels

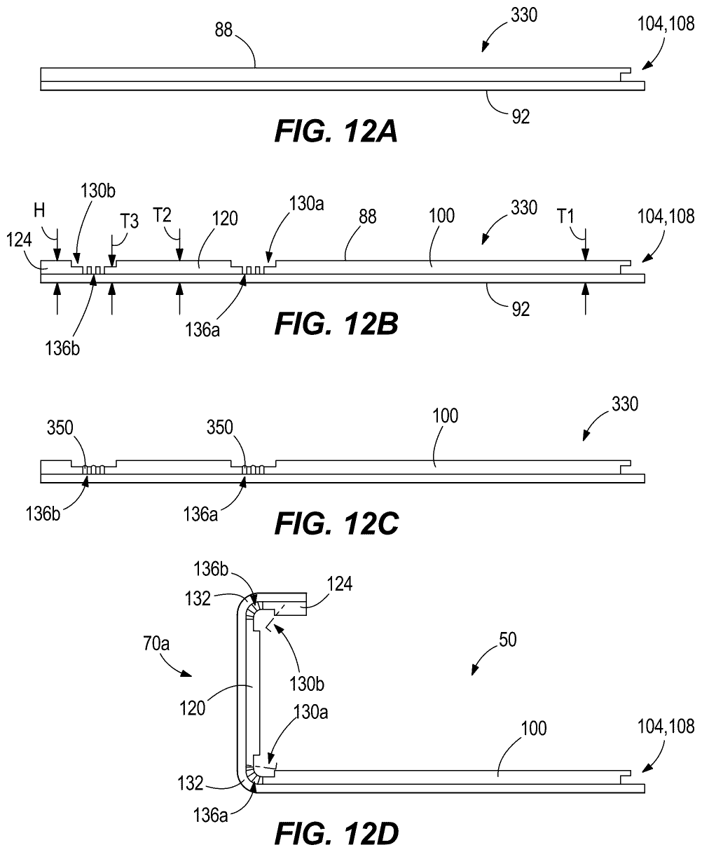

FIGS. 2A-2C and 9 illustrate further details of the nose flooring panel 50 with the polygonal cap 70a. The nose flooring panel 50 with the polygonal cap 70a includes the tread portion 100, a first wall 120 and a second wall 124. The first wall 120 is coupled to the tread portion 100 by a first corner 128 and is generally perpendicular to the tread portion 100. At least a portion of the first wall 120 has a second thickness T2 (FIG. 9, see also FIG. 12B) that may be equal to the first thickness T1 of the tread portion 100. The second wall 124 is coupled to the first wall 120 by a second corner 132 and is generally parallel to the tread portion 100. In the illustrated embodiment, the second wall 124 overlaps a portion of the tread portion 100 when the cap 70 is formed into the polygonal shape. The second wall 124 includes a maximum height H (FIG. 9) that is equal to the first thickness T1 of the tread portion 100.

Further with reference to FIG. 9 (see also FIG. 12B), each of the first corner 128 and the second corner 132 includes a third thickness T3 (only shown in the first corner 128) that is less than the first thickness T1. Also, each of the first corner 128 and the second corner 132 includes a plurality of grooves 136a, 136b. The grooves 136a, 136b extend parallel to the axis 96 between the first end 80 and the second end 84.

Further with respect to FIG. 9, the first wall 120 and the second wall 124 are spaced apart from one another and from the tread portion 100 by recesses 130a, 130b. The recesses 130a, 130b provide spacing between the first wall 120, the second wall 124, and the tread portion 100. In other words, as shown, the first wall 120 does not contact the tread portion 100 or the second wall 124 and the second wall 124 does not contact the tread portion 100 or the first wall 120. Instead, the first wall 120 is spaced apart from the tread portion 100 by recess 130a having a first distance D1 and spaced apart from the second wall 124 by a recess 130b a second distance D2. Also, the second wall 124 is spaced apart from the tread portion 100 by a third distance D3 resembling the thickness of the cap 70. As will be described in further detail, the recesses 130a, 130b enable the nose flooring panel 50 to be shaped to have a polygonal cap 70a. Without the recesses 130a, 130b, the tread portion 100, the first wall 120, and the second wall 124 would collide during the cap forming process and prevent the panel 50 from being bent into the shape of the polygonal cap 70a.

FIGS. 5-8 and 10 illustrate further details of a nose flooring panel 50 with a curved the cap 70b. That is, as shown in FIG. 10, the cap 70b has an inner arcuate surface 150 that is integrally formed with an extends from the inside 88 of tread portion 100. Likewise, the cap 70 has an outer arcuate surface 154 that extends from the outside 92 of the tread portion 100. The cap 70 has a second thickness T2′ that is less than the first thickness T1 of the tread portion 100. The inner surface 150 of the cap 70 has a plurality of grooves 158 formed therein. The grooves 158 extend parallel to the axis 96 between the first end 80 and the second end 84. In the illustrated embodiment, the grooves 158 extend along a majority of the circumference of the inner surface 150 of the cap 70. Additionally, a cover member 162 is coupled to the inner surface 150 of the cap 70 to help maintain the shape of the cap 70. The cover member 162 covers the grooves 158 and may be secured to the inner surface 150 by an adhesive. In some embodiments, the cover member 162 may be formed from paper or foil or any other suitable material to help maintain the shape of the cap 70. In other embodiments, the cover is a melamine resin-impregnated paper or a plastic sheet.

### Tread Flooring Panels

The nose flooring panel 50 may optionally be coupled to one or more tread flooring panels 54, as shown in FIGS. 6A-6C. The tread flooring panels 54 each include a first end 200, a second end 204 opposite the first end 200, an inside 208 (e.g., first side), and an outside 212 (e.g., second side) opposite the inside 208. Each tread flooring panel 54 has a second coupling edge 220 extending between the first end 200 and the second end 204 thereof. The second coupling edge 220 of the tread flooring panel 54 is configured to mechanically couple to the first coupling edge 104 of the nose flooring panel 50. Accordingly, as shown in FIGS. 9 and 10, the second coupling edge 220 includes a second interface 224 that is complementary to the first interface 108 of the nose flooring panel 50. In the illustrated embodiment, the second interface 224 is a tongue or projection configured to be received in the groove of the first interface 108. Additionally, the tread flooring panel 54 may include a flat edge 228a opposite the second coupling edge 220. The flat edge 228a provides a finished back edge of the flooring panel 54a.

As shown in FIGS. 1 and 5, collectively, the tread portion 100 of the nose flooring panel 50 and the tread flooring panel 54 may cover the tread 26 of the stair. When a stair 14 includes a deeper tread 26 (i.e., measured from front to back of the stair 14), additional tread flooring panels 54 may be used to create greater depth. In the embodiment of FIGS. 2A-2C and 6A-6C, a second tread flooring panel 54b (e.g., an intermediate tread flooring panel) may be coupled between the nose flooring panel 50 and the first tread flooring panel 54a. In such case, the intermediate tread flooring panel 54b may include a third coupling edge 228b instead of the flat edge 228a like that of the first tread flooring panel 54a. The third coupling edge 228b is configured to mechanically couple to the second coupling edge 220a of the first tread flooring panel 54a. The third coupling edge 228b includes the third interface 226 that is complementary to the second interface 224 of the first tread flooring panel 54a. In the illustrated embodiment, the third interface 226 is a groove configured to receive the tongue of the second interface 224. Collectively, the first thread flooring panel 54a, the intermediate tread flooring panel 54b, and the tread portion 100 of the nose flooring panel 50 may cover the tread 26 of the stair 14. When used together, the first tread flooring panel 54a and the intermediate tread flooring panel 54b may be suitable for stairs 14 having treads 26 with a greater depth (than for example the depth of the stairs 14 shown in FIGS. 1 and 5). It should be understood that one or more intermediate tread flooring panels 54b may be added depending on the overall depth of the tread desired. Similarly, in many cases an intermediate tread flooring panel 54b may not be necessary.

### Pre-Assembled Panels

To help make installation of the flooring system 10 more efficient and simply, one or more nose flooring panel 50 and/or tread flooring panel 54 may be coupled together in a pre-assembled section, referred to as a pre-assembled nose-tread assembly 250. The pre-assembled nose-tread assembly 250 allows for installation of multiple flooring panels 50, 54 onto the tread of the stair 14 as a single unit. (e.g., FIGS. 2A-2C and 6A-6C). The nose-tread assembly 250 may include nose flooring panels 50 and tread flooring panels 54 that all have the same length (i.e., or width from left to right when facing the stair 14). FIGS. 2A and 6A are examples of nose-tread assemblies with equal length nose flooring panels 50 and tread flooring panels 54. Alternatively, the nose-tread assembly 250 may include nose flooring panels 50 and/or tread flooring panels 54 that have different lengths in order to create a parquet effect. FIGS. 2C and 6C are examples of nose-tread assemblies with a parquet effect. Specifically, the nose flooring panel 50 is composed of two panels with a shorter length that stretch across the length of the tread flooring panel 54 (i.e., the width of the stair 14 from left to right when viewing the stair). Similarly, in other embodiments, multiple tread flooring panels 54 of a shorter length may be used to extend across the entire length of the nose flooring panel 50. However, it should be understood that different configurations with greater or fewer treads flooring panels 54 and/or nose flooring panels 50 are possible.

As described above, nose flooring panels 50, first flooring panels 54a, and intermediate flooring panels 54b may be coupled together in various arrangements. Once the panels 50, 54a, 54b are mechanically coupled to one another, they may be secured relative to one another using securing members 260, 264, 268, 272 to create the preassembled nose-tread assembly 250. For example, a first securing member 260 (i.e., inner securing member) may be coupled to the insides 88, 208b of each of the nose flooring panel 50 and the intermediate tread flooring panel 54b over the first coupling edge 104 and the second coupling edge 220b. Similarly, a second securing member 264 (i.e., inner securing member) may be coupled to the insides 208b, 208a of each of the intermediate tread flooring panel 54b and the tread flooring panel 54a over the third coupling edge 228b and the second coupling edge 220a. Additionally, a third securing member 268 (i.e., an outside securing member) may be coupled to the outsides 92, 212b of each of the nose flooring panel 50 and the intermediate tread flooring panel 54b over the first coupling edge 104 and the second coupling edge 220b. Similarly, a fourth securing member 272 (i.e., an outside securing member) may be coupled to the outsides 212b, 212a of each of the intermediate tread flooring panel 54b and the tread flooring panel 54a over the third coupling edge 228b and the second coupling edge 220a. The securing members 260, 264, 268, 272 are configured to enable the pre-assembled nose-tread assembly 250 to be installed in a single step, as discussed below.

In the illustrated embodiment, the first and second securing members 260, 264 are each an elongate strip of tape positioned on the insides of the panels 50, 54, which use adhesive to maintain the coupling of the respective panels. In other embodiments, the securing members 260, 264 may be combined into a single securing member formed from plastic, wood, or composite material (e.g., high-density fiberboard, “HDF”) and adhesively coupled to the insides 88, 208a, 208b of the panels 50, 54b, 54a to maintain the coupling of the respective panels 50, 54b, 54a. The benefit of using securing members is they enable panels to have some flexibility (e.g., to bend, swell, contract, etc.) without separating from one another or breaking, which is common when adhesive is used to couple adjacent panels. Whereas the first and second securing members 260, 264 are not configured to be removed, the third and fourth securing members 268, 272 are configured to be removed after installation is complete. The third and fourth securing members 268, 272 are positioned on the outsides of the panels 50, 54. Therefore, the third and fourth securing members 268, 272 may be an elongate strip of tape that includes a no-residue adhesive.

In the illustrated embodiments of FIGS. 2A-2B and 6A-6B, the length of the first tread flooring panels 54a, the intermediate tread flooring panels 54b, and the nose flooring panel 50 are all the same length, and all of the flooring panels 50, 54a, 54b all extend across the entire width of the stair 14. Therefore, securing members 260, 264, 268, 272 extend lengthwise along the entire seem between the flooring panels 50, 54a, 54b. In other embodiments, the length of the first tread flooring panels 54a, the intermediate tread flooring panels 54b, and/or the nose flooring panel 50 have different lengths. In this case, the flooring panels 50, 54a, 54b may be staggered relative to one another to create a parquet effect. An additional securing member 400 may be used to couple the ends of adjacent panels 50, 54a, 54b together when creating a staggered or a parquet effect.

In one specific context, as shown in FIGS. 2C and 6C, two nose flooring panels 50 are coupled to one another (via positive engagement, such as a tongue and groove engagement or the like, and/or a securing member 400) and a single tread flooring panels 54a via securing members (such as securing members 260, 268 discussed above). The various assembly options for the pre-assembled nose-tread assembly 250 gives the ability of the panels to be coupled to one another and create a parquet effect that is simple to install.

### End Caps

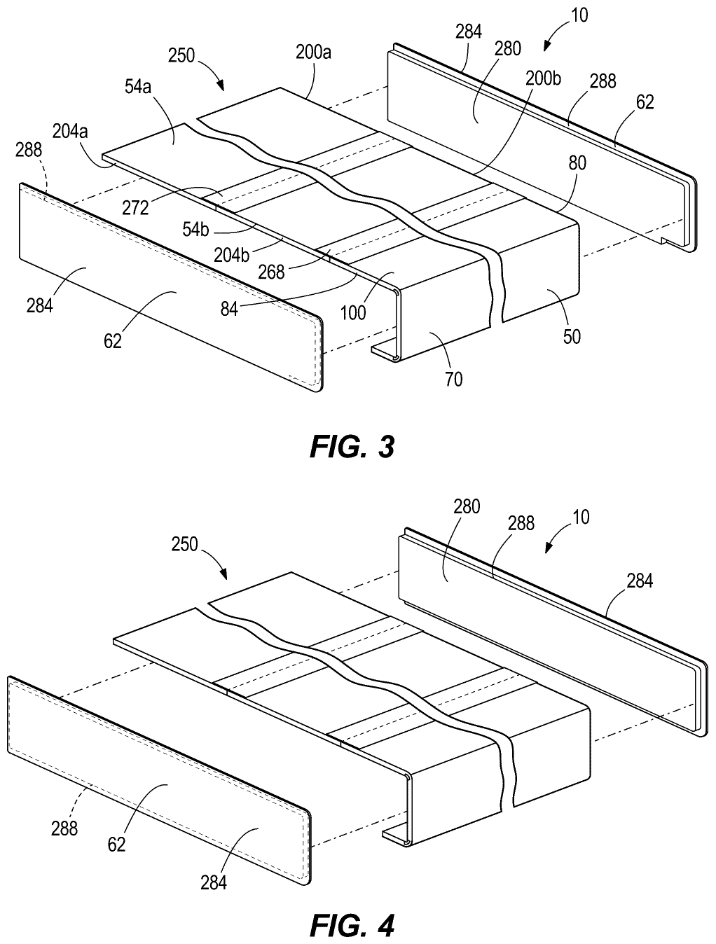

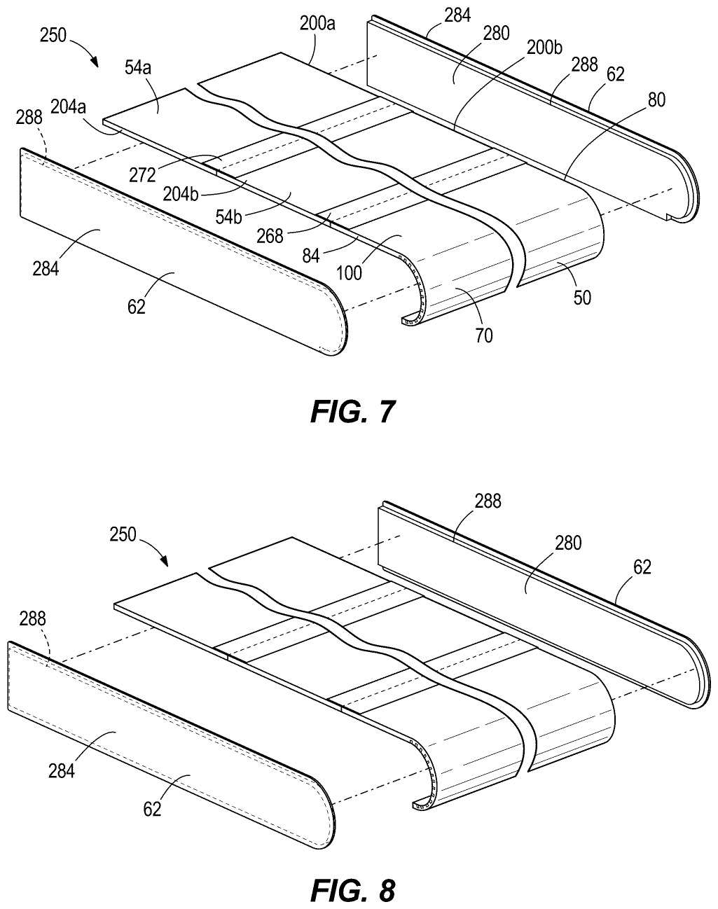

As previously mentioned, end caps 62 may be coupled to the first and second ends 80, 84 of the nose flooring panels 50. Depending on the desired size, the end caps 62 may extend beyond the nose flooring panels 50 to the tread flooring panels 54a and/or the intermediate tread flooring panels 54b. FIGS. 3-4 and 7-8 provide a detailed view of some embodiments of an end cap 62. The end caps 62 each include a first side 280 (e.g., inside) and a second side 284 (e.g., outside) opposite the first side 280. The end caps 62 each include a groove 68 that extends about a portion of a perimeter of the first side 280. The grooves 288 are sized and shaped to receive the first end 80 and the second end 84 of the nose flooring panels 50 and all or a portion of the first end 200a, 200b and the second end 204a, 204b of the tread flooring panels 54a, 54b. That is, the grooves 288 of FIGS. 3-4 have a generally polygonal (e.g., square) portion to receive the polygonal (e.g., square) cap 70 of the nose flooring panels 50. Similarly, the grooves 288 of FIGS. 7-8 have a generally semicircular or arcuate portion to receive the curved cap 70b of the nose flooring panels 50.

### Installation

One benefit of the present system is the ability to use component parts that are all made with the same material (such as, but not limited to, wood, laminate with a solid core, PVC-based (e.g., luxury vinyl flooring “LVT”, stone plastic composite “SPC”, wood plastic composite “WPC”, etc.) materials with a solid core, and vinyl with a solid core). High quality floors are often made using the materials listed above, among others. However, creating a stair system using the same material as the rest of the main floor area can be difficult. For example, it is difficult to form panels into a nose flooring panel with a polygonal or curved shape. Therefore, some existing stairs systems use less desirable materials on the nose flooring panels on the nose flooring panel and/or the tread flooring panels. In this situation the stairs and main floor area are composed of different materials that do not always have matching color, texture, or patterns. In the present system, the nose flooring panels 50, the tread flooring panels 54, the riser flooring panels 58, and the end caps 62 are formed from the same material that the rest of the floor (e.g., at the top and bottom of the stairs 14, staircase 18) is formed from. Therefore, the flooring system 10 is the same material as and matches the flooring for the rest of the space.

In one exemplary method of installation, the installer applies adhesive to a riser flooring panel 58 then adheres the riser panel 58 to the riser 22 of the lowest stair 14. Referring to FIGS. 9 and 10, a support 292 may be coupled to the stair edge 30 at the top of the riser 22 or the end of the tread 26 in order to extend the edge of the stair beyond the tread 26. The support 292 may be coupled to the stair edge 30 by adhesive and/or suing fastener. As shown in FIG. 9, when the stair is a box stair, the support 292 may be a polygonal shape (in cross-section) that corresponds to the polygonal shape of the nose flooring panel 50. As shown in FIG. 10, when the stair is a curved stair, the support 292 may be a curved or rounded shape (in cross-section) that corresponds to the curved shape of the nose flooring pane 50. On the other hand, when the stair edge 30 already has a polygonal or arcuate surface that projects outwardly from the riser 22, the support 292 is not necessary.

Then, the installer applies adhesive to the nose flooring panel 50 and the one or more tread flooring panels 54 of the pre-assembled nose-tread assembly 250, discussed above. Specifically, adhesive is applied to the insides 88, 208 of the one or more nose flooring panel 50 and the one or more tread flooring panels 54. Then, in a single step, the installer adheres the first side of the pre-assembled nose-tread assembly 250 to the stair edge 30, the support 292 (if included), and the tread 26. As shown in FIGS. 9 and 10, the cap 70 surrounds either the polygonal or arcuate projecting surface or the support 292 (depending on the configuration of the stair), while the tread portion 100 of the one or more nose flooring panels 50 and one or more assembled tread flooring panels 54 adhere to the tread 26 of the stair 14. Additionally, the cap 70 is configured to abut the adjacent riser flooring panel 58. In this way, for each stair, the one or more nose flooring panels 50 and one or more tread flooring panels 54 can be installed together to the stair 14 in a single step.

This installation process is repeated for each stair 14. Then, once all pre-assembled nose-tread assemblies 250 have been coupled to the respective stair 14, the end caps 62 are installed to one or both ends of each stair 14 (depending on the configuration of the stairs 14). That is, for the visible ends of each stair 14, the installer applies adhesive to the first side 280 of one of the end caps 62 and the groove 288 thereof and adheres the end cap 62 the respective side wall 34, 38 of the stair 14 such that the respective first end 80, 200 or second end 84, 204 of the nose flooring panel 50 and at least a portion of the one or more tread flooring panels 54 are received within the groove 288. Once a predetermined amount of time has passed (e.g., 48 hours), the third and fourth securing members 268, 272 on the outsides 952, 212 of the pre-assembled nose-tread assembly may be removed therefrom. As previously mentioned, the securing members 260 and 264 positioned on the insides 88, 208 of the nose flooring panel 50 and the tread flooring panels 54 are not removed, and thus, can help to maintain a connection between the panels during and after installation.

Alternatively, when installing nose flooring panels 50 and tread flooring panels 54a, 54b that are not pre-assembled, the installation process involves separately adhering each flooring panel 50, 54a, 54b to the tread 26 of the stair 14. For example, first the nose flooring panel 50 is positioned on the edge 30 of the stair 14. Then a tread flooring panel 54a is coupled to the first coupling edge 104 of the nose flooring panel 50 and adhered to the tread 16 of the stair 14. If the tread 16 is a wide tread, an intermediate tread flooring panel 54b is first positioned adjacent the nose flooring panel 50 and then the next tread flooring panel 54a is coupled to the intermediate tread flooring panel 54b.

### Method of Forming a Nose Flooring Panel

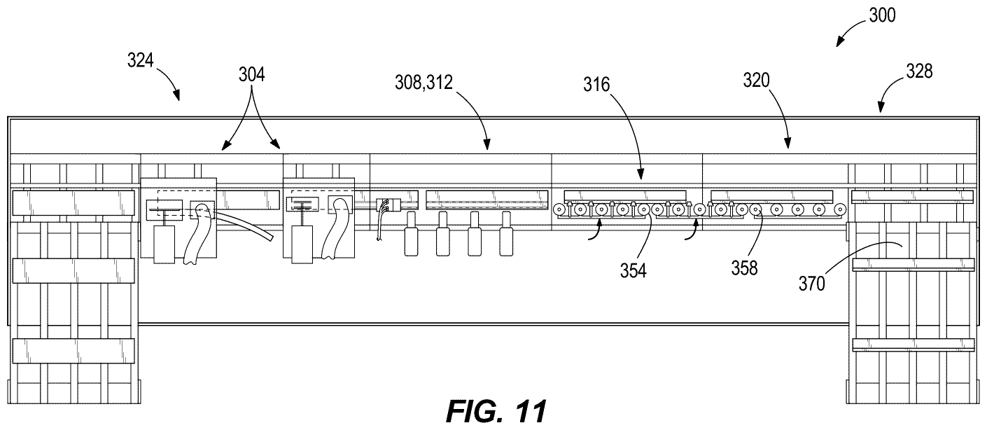

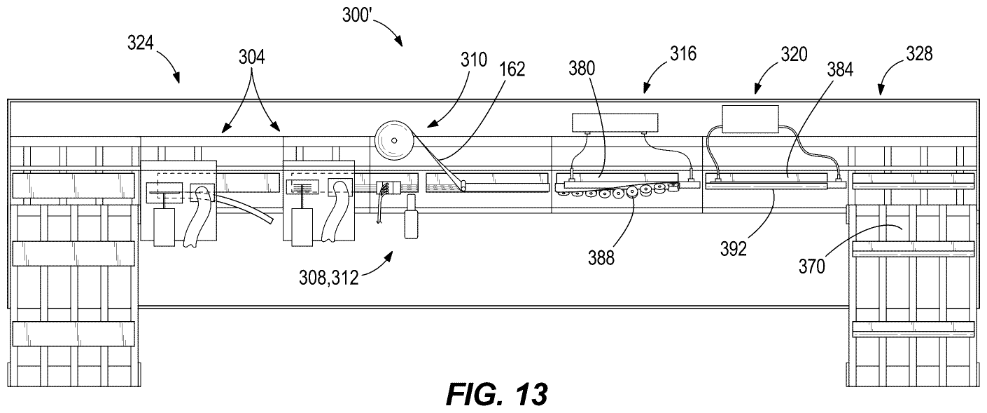

As previously mentioned, nose flooring panels 50 are difficult to manufacture in such a way to match the rest of the floor. FIGS. 11 and 13 provide exemplary flooring panel forming machines 300, 300′ that may be used to create nose flooring panels 50 through an automated or semi-automated process. Flooring panel forming machines 300, 300′ are configured to transform a flat, rectangular panel into the above-describe nose flooring panel 50 having the cap 70 with either the polygonal or curved configuration. The flooring panel forming machines 300, 300′ are configured transform a flat rectangular flooring panel 330 into the nose flooring panel 50 by passing the rectangular flooring panel 330 linearly through a plurality of stages and without removing the panel from the machine 300, 300′ until the process is complete. The tread portion 100 of the flooring panel 330 is supported by the flooring panel forming machine 300, 300′, enabling the machine 300, 300′ to move the flooring panel 330 continuously from one stage to the next within the imaginary plane. Since the tread portion 100 remains largely unchanged during the process, it is well-suited to be supported and/or gripped by the machine 300, 300′ for transport through the various stages of the process.

Alternatively, in some embodiments, the flooring panel 330 may remain in place for one or more stage(s) while components of the machine 300, 300′ move towards the stationary flooring panel 330 to execute the stage. In either case, the machine 300, 300′ provides for a streamline manufacturing process with limited or no manual processes between each stage. Accordingly, the machine 300, 300′ improves manufacturability of nose flooring panels by maximizing efficiency, reducing cost, and limiting manual intervention. As will be described in further detail below, the method 1500 of forming a nose flooring panel 50 with a polygonal cap 70a and the method of 1600 of forming a nose flooring panel 50 with a curved cap 70b include many of the same steps. However, for clarity these methods 1500 and 1600 will be described separately.

### Polygonal Cap

FIGS. 11, 12A-12D, and 15 illustrate a system and method of manufacturing a nose flooring panel 50 having a polygonal cap 70a. As shown in FIG. 11, the flooring panel forming machine 300 of for the nose flooring panel 50 having the polygonal cap 70a includes a material removal stage 304, an adhesive application stage 308, a heating stage 312, a bending stage 316, and a cooling stage 320. In some embodiments, the flooring panel forming machine 300 may further include a panel joining stage 324 prior to the material removal stage 304 and a cutting stage 328 after the cooling stage 320. Each of the stages are consecutively arranged and collectively define an imaginary plane.

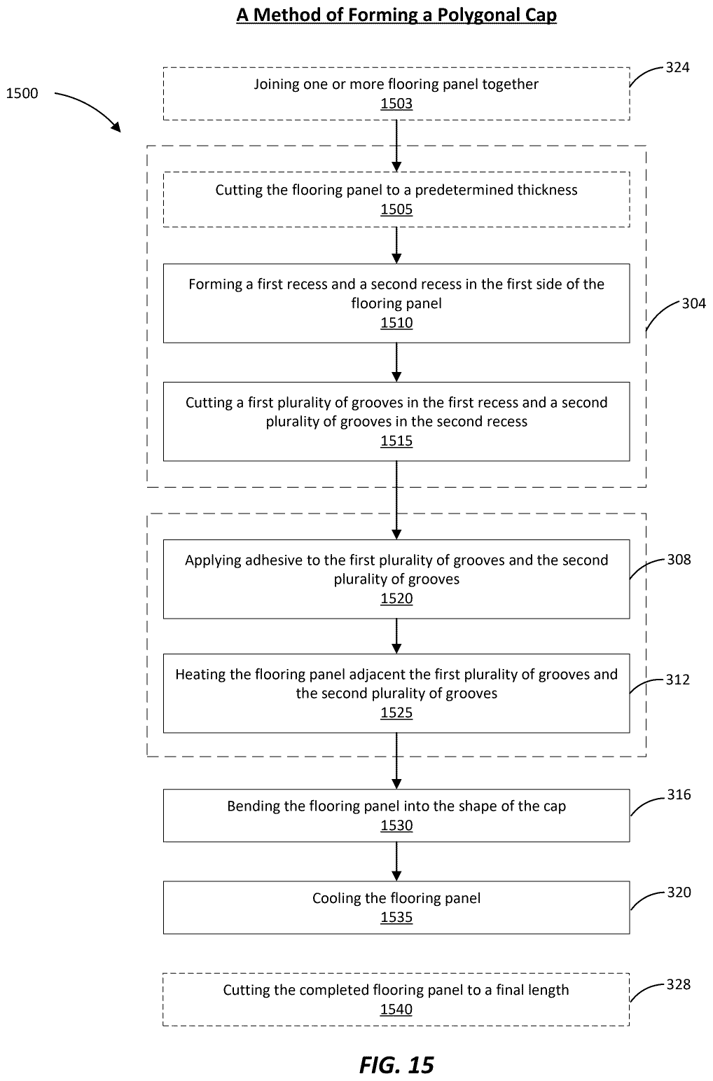

FIG. 15 illustrates a method of manufacturing a nose flooring panel 50 with a polygonal cap 70a. During the material removal stage 304, the method 1500 includes cutting a flooring panel 330 into a desired size and shape. In some embodiments, the method includes an initial step 1505 of cutting the flooring panel 330 to a predetermined depth such that the tread portion 100 is of a desired thickness T1. However, in some embodiments, the flooring panel 330 may already come in a desired thickness T1 and this step 1505 may be skipped. The method 1500 includes supporting a flooring panel 330 on the flooring panel forming machine 300 with the outside 92 of the flooring panel 330 facing downwards towards the flooring panel forming machine 300 and the inside 88 facing upwards, as shown in FIG. 12A.

During the material removal stage 304, the method 1505 includes forming a first recess 130a in the inside 88 of the flooring panel 330 and a second recess 130b in the inside 88 of the flooring panel 330 (Step 1510). The first and second recesses 130a, 130b are spaced apart from one another, as shown in FIG. 12B. The first and second recesses 130a, 130b are formed by milling the flooring panel 330 by one or more cutting blades in the material removal stage 304 of the machine 300. Next, the method 1500 includes cutting a first plurality of grooves 136a, 136b in a recessed surface of the first recess 130a and a second plurality of grooves 136b in a recessed surface of the second recess 130b (Step 1515). In other embodiments, the recesses 130a, 130b and the associated grooves 136a, 136b may in formed in a single step, which combines Steps 1510 and 1515. Each of the first plurality of grooves 136a extends parallel to the axis 96 (which is into the page at FIG. 12B). Likewise, each of the second plurality of grooves 136b extends parallel to the axis 96.

With reference to FIG. 12B, a first portion of the flooring panel 330 (which will become tread portion 100 of the nose flooring panel 50) extends between the first end 200 and the first plurality of grooves 136b. A first segment of the flooring panel 330 (which will become the first wall 120) is defined between the first plurality of grooves 136a and the second plurality of grooves 136b and a second segment of the flooring panel 330 (which will become the second wall 124) is defined between the second plurality of grooves 136b between the second end 204. The first and second plurality of grooves 136a, 136b are formed by milling the flooring panel 330 in the material removal stage 304, and in particular, by one or more cutting blades of the material removal stage 304.

The flooring panel 330 thus has a first recess 130a surrounding the first plurality of groove 136a and a second recess 130b surrounding the second plurality of grooves 136b. Therefore, the first plurality of grooves 136a and the second plurality of grooves 136b are recessed relative to the tread portion 100 portion of the flooring panel 330. Accordingly, a depth of each of the first plurality grooves 136a and a depth of each of the second plurality of grooves 136b is less than half the first thickness T1 (i.e., thickness of the tread portion 100) of the flooring panel measured between the inside 88 and the outside 92. The depth D of the grooves 136a, 136b may be the same or similar to that discussed below relative to the grooves 158 of the curved cap 70b.

Once the material removal stage 304 is complete, the flooring panel 330 moves to an adhesive application stage 308 of the machine 300 (Step 1520). Referring to FIG. 12C, the adhesive application stage 308 includes applying an adhesive 350 to each of the first plurality of grooves 136a and the second plurality of grooves 136b. The adhesive 350 may be applied using any suitable means of applying adhesive. For example, the adhesive 350 may be applied by nozzles that spray the adhesive 350 onto the grooves 136a, 136b. Alternatively, the adhesive 350 may be heated such that it is melted onto first and second plurality of grooves 136a, 136b of the flooring panel 330.

In the illustrated embodiment, the adhesive 350 may include a hot-melt polyurethane, which is configured to chemically cure over time by cross-linking the molecules by ambient moisture. The hot-melt polyurethane has a viscosity that ranges from 30,000 mPa·s to 60,000 mPa·s at 150 degrees Celsius. Once cured, the hot-melt polyurethane will not melt again, which is important to ensuring the cap 70a maintain its shape. In other embodiments, the adhesive 350 may include a fast curing two-component reactive adhesive system. In some examples, the material of the nose flooring panel 50 may be primed, such that the material of the nose flooring panel 50 is better able to bond with the adhesive 350 as it cures. In such case, the flooring machine 300 includes a priming stage prior to the adhesive application stage 308.

Once the adhesive is applied, the flooring panel 330 may advance along the imaginary plane to the heating stage 312 of the machine 300 (Step 1525). The heating stage 312 includes heating the flooring panel 330 at least at or adjacent to the areas associated with each of the first plurality of groove 136a and the second plurality of grooves 136b. The flooring panel 330 is heated until it is sufficiently hot in the areas with the first plurality of grooves 136a and the second plurality of grooves, 136b, such that the flooring panel 330 may be bent to form the shape of the polygonal cap 70. In the illustrated embodiment, as shown in FIG. 11, the adhesive application stage 308 and the heating stage 312 are combined. In this case, the flooring panel 330 may remain in the same place within the machine 300 during both the adhesive application stage 308 and the heating stage 213. However, in other embodiments, the flooring panel 330 may be moved along the imaginary plane from one stage to another.

That is, the adhesive 350 is heated and applied to the first and second plurality of grooves 136a, 136b. For example, the adhesive 350 may be heated to 150 degrees Celsius to 160 degrees Celsius. In other embodiments, the adhesive 350 may be heated to between 110 degrees Celsius and 180 degrees Celsius. The heat from the heated adhesive 350 is enough to soften material of the panel 330 in the areas including the first and second plurality of grooves 136a, 136b. This is possible because the thickness T3 of the flooring panel 330 between the outside 92 and surfaces of the grooves 136a, 136b where the adhesive 350 is received is very thin. The thickness T3 is approximately 1.6 mm in the illustrated embodiment but may be between 1.2 mm and 2.4 mm in other embodiments.

In some embodiments, the heating stage 312 may be separate from the adhesive stage 308. With respect to the heating stage 312, the flooring panel 330 may be heated between the tread portion 100 and the second end 204. Alternatively, the flooring panel 330 may be heated in an area incorporating both the first recess 130a and the second recess 130b, and therefore, the first plurality of grooves 136a and the second plurality of grooves 136b. The heating stage 312 may be performed by blowing air having a temperature of between 60 degrees Celsius and 100 degrees Celcius onto the outside 92 of the flooring panel 330, although any suitable means of applying heat may be used (such as via the use of a radiator).

The machine 300 further includes a bending stage 316 in which the flooring panel 330 is bent to form the shape of the polygonal cap 70a (Step 1530). As shown in FIG. 12D, the flooring panel 330 is bent at or adjacent to the areas associated with each of the first plurality of grooves 136a and the second plurality of grooves 136b such that the first segment defines the first wall 120 of the polygonal cap 70a and the second segment defines the second wall 124 of the polygonal cap 70a. With respect to the bending step, the machine 300 is configured to bend the first segment 120 relative to the tread portion 100 and bend the second segment 124 relative to the first segment 120 at the same time. Once bent, a first set of rollers is configured to apply pressure to the first segment 120 and a second set of rollers 354 is configured to apply pressure to the second segment 124 as the flooring panel 330 is advanced through the machine 300. As noted above, the bending step (Step 1530) creates the first corner 128 from the first recess 130a, the first wall 120 from the first segment, the second corner 132 from the second recess 130b, and the second wall 124 from the second segment.

Finally, the method includes a cooling stage 320 (Step 1535). With respect to the cooling stage 320, the entire cap 70a may be cooled as rollers 358 continue to put pressure on the first and second walls 120, 124. Alternatively, the cap 70 may be cooled in areas incorporating the first corner 128 and the second corner 132, and therefore, the first plurality of grooves 138a and the second plurality of grooves 136b. The cooling step may be performed by blowing air having a temperature of between −2 degrees Celsius −6 degrees Celsius) onto the first side of the flooring panel, although any suitable means of applying a cooling temperature may be used. The cooling step cures the adhesive 350. Thus, the cooling step, in combination with the adhesive 350, maintains the shape of the polygonal cap 70a. Once the nose flooring panel 50 is completed, it may be guided to a platform 370, where an operator may remove it from the machine 300. Accordingly, the flooring panel forming machine 300 moves the flooring panel 330 through the various stages to create the nose flooring panel 50 having a polygonal cap 70a. In other words, the nose flooring panel 50 is formed using a linear, automated process and without being removed until it has been formed.

### Curved Cap

FIGS. 13, 14A-14D, and 16 illustrate is system and method of manufacturing a nose flooring panel 50 having a curved cap 70b. As shown in FIG. 13, the flooring panel forming machine 300′ of for the nose flooring panel 50 having the curved cap 70b includes a material removal stage 304, an adhesive application stage 308, a cover member application stage 310, a heating stage 312, a bending stage 316, and a cooling stage 320. In some embodiments, the flooring panel forming machine 300′ may further include a panel joining stage 324 prior to the material removal stage 304 and a cutting stage 328 after the cooling stage 320. Each of the stages are consecutively arranged and collectively define an imaginary plane.

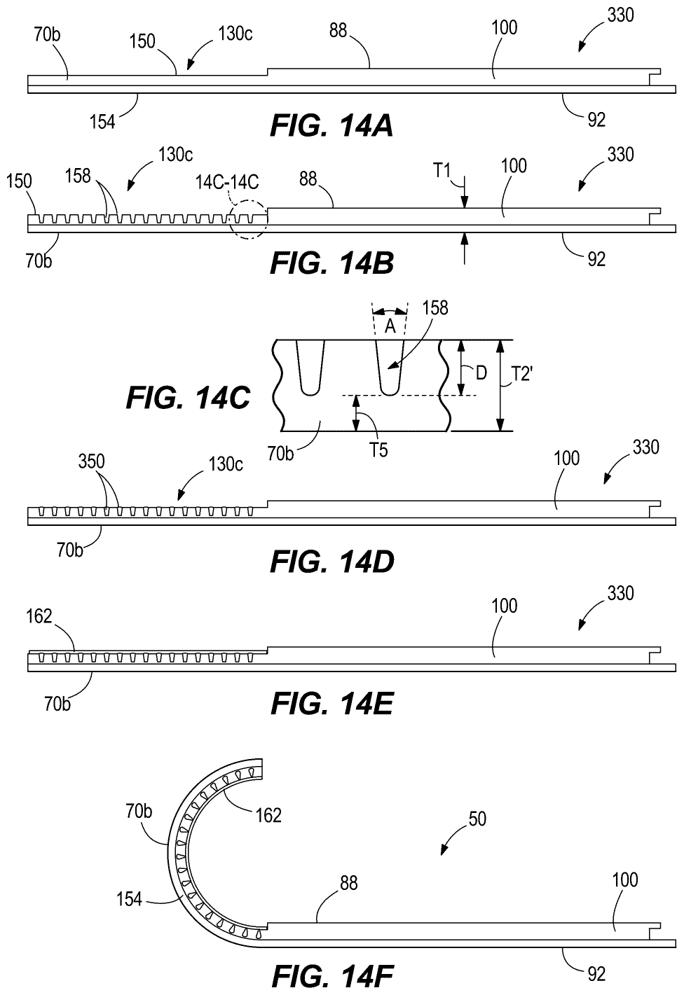

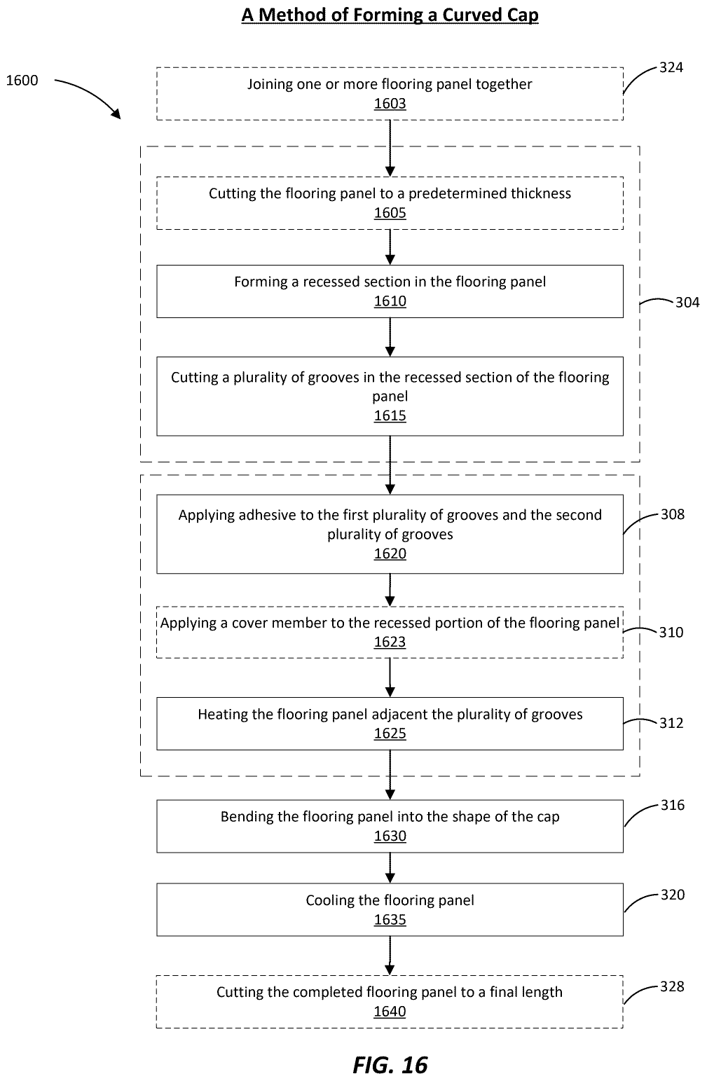

FIG. 16 illustrates a method of manufacturing a nose flooring panel 50 with a curved cap 70b. During the material removal stage 304, the method 1600 includes cutting a flooring panel 330 into a desired size and shape. In some embodiments, the method 1600 includes an initial step 1605 of cutting the flooring panel 330 to a predetermined depth such that the tread portion 100 is of a desired thickness T1. However, in some embodiments, the flooring panel 330 may already come in a desired thickness T1 and this step may be skipped. The method 1600 includes supporting a flooring panel 330 on the flooring panel forming machine 300′ with the outside 92 of the flooring panel 330 facing downwards towards the flooring panel forming machine 300 and the inside 88 facing upwards, as shown in FIG. 14A. The rectangular flooring panel 330′ is moved by the flooring panel forming machine 300′ such the panel 330 from one stage to the next within the imaginary plane.

During the material removal stage 304, the method 1605 includes removing material from the inside 88 of the flooring panel 330 to form a recessed portion 130c in the area where the cap 70b will be formed (Step 1610). More specifically, as shown in FIG. 14B, the flooring panel has a first portion (e.g., a tread portion 100) with the first thickness T1 measured between the inside 88 and the outside 92 and a second portion (i.e., a recessed portion 130c) with a second thickness T2′ measured between the inside 88 and the outside 92. The second thickness T2′ is less than the first thickness T1. In some embodiments, the recessed portion 130c is be formed during the material removal stage 304 by removing material from the inside 88 of the flooring panel 330 (Step 1610). In other embodiments, the recessed portion 130c may be formed by removing material from the flooring panel 330 prior to being inserted into the flooring panel forming machine 300′. The recessed portion 130c may be formed by a router or other cutting tool configured to create the recessed portion 130c.

The material removal stage 304 further includes cutting a plurality of grooves 158 along a surface 150 of the recessed portion 130c (Step 1615). Each of the plurality of grooves 158 extends parallel to the axis 96 (which is into the page in FIG. 14B). The plurality of grooves 158 is formed by milling the flooring panel 330 in the material removal stage 304, and in particular, by one or more cutting blades of the material removal stage 304.

Referring to FIG. 14B, once the material removal stage 304 is complete, the flooring panel 330 thus has grooves 158 that extend along a majority of the recessed portion 130c of the flooring panel 330. In the illustrated embodiment, the grooves 158 extend along at least 80% of the length L of the recessed portion 130c. In the other embodiments, the grooves 158 extend along at least 50% of the length L of the recessed portion 130c, along at least 60% of the length L of the recessed portion 130c, or along at least 70% of the length L of the recessed portion 130c. There are at least 10 grooves 158 which are spaced closely together to allow the flooring panel 330 to be bent relatively easily with minimal heat applied to the flooring panel 330. In the illustrated embodiment, there are seventeen grooves 158. In other embodiments, there may be greater or fewer grooves 158, however, it should be understood that if there are too few grooves 158 or they are not properly spaced, it will be more difficult to bend the flooring panel 300.

As shown in FIG. 14C, the grooves 158 are generally V-shaped grooves and have a depth D that is less than half the first thickness T1′ of the tread portion 100. Additionally, the depth D of the grooves 158 is about 60% of the second thickness T2′ of the recessed portion 130c. In one example, the second thickness T2′ is 4.0 mm and the grooves 158 each have a depth of 2.4 mm. Accordingly, a thickness T5 between the outside 92 and bottom of each of the grooves 158 is 1.6 mm. In other embodiments, the second thickness T2′ may be less than 5.0 mm, the grooves may each have a depth D of between 1.8 mm and 3.0 mm, and a thickness T5 between the outside 92 and bottom of each of the grooves 158 may be between 1.2 mm and 2.4 mm. The distance between the centers of adjacent grooves is 3.5 mm, but may be between 2.0 mm and 5.0 mm. The V-shaped grooves create an angle A of about 12 degrees, although the angle A may be greater or less than 12 degrees.

Once the material removal stage 304 is complete, the flooring panel 330 moves to an adhesive application stage 308 of the machine 300′ (Step 1620). Referring to FIG. 14D, the adhesive application stage 308 includes applying an adhesive 350 to each of the first plurality of grooves 158. The adhesive 350 may be applied using any suitable means of applying adhesive. For example, the adhesive 350 may be applied by nozzles that spray the adhesive 350 onto the grooves 158. Alternatively, the adhesive 350 may be heated such that it is melted into the grooves 158 of the flooring panel 330.

In the illustrated embodiment, as in the previous embodiment, the adhesive 350 may include a hot-melt polyurethane, which is configured to chemically cure over time as it cools by cross-linking the molecules by ambient moisture. The hot-melt polyurethane has a viscosity that ranges from 30,000 mPa·s to 60,000 mPa·s at 150 degrees Celsius. Once cured, the hot-melt polyurethane will not melt again, which is important to ensuring the cap 70b maintain its shape. In other embodiments, the adhesive 350 may include a fast curing two-component reactive adhesive system. In some examples, the material of the nose flooring panel 50 may be primed, such that the material of the nose flooring panel 50 is better able to bond with the adhesive 350 as it cures. In such case, the flooring machine 300 includes a priming stage prior to the adhesive application stage 308.

Once the adhesive is applied, the flooring panel 330 advances along the imaginary plane to the cover member application stage 310 of the machine 300′. Here, the method 1600 further includes applying the cover member 162 onto the recessed portion 130c over the plurality of grooves 158 (Step 1623). As shown in FIG. 14D, the cover member 162 extends over and covers the plurality of grooves 158. The cover member 162 helps to maintain the curved shape of the cap 70b after the flooring panel 330 is bent. The cover member 162 improves the strength and integrity of the cap 70b. Additionally, it is also used to protect against the adhesive 350 leaking onto the downstream elements of the machine 300′. The cover member 162 may be any suitable material capable of achieving these goals. For example, the cover member 162 may be paper, foil, a melamine resin-impregnated paper, or a plastic sheet. In some embodiments, the cover member 162 and the cover member application stage 310 may be omitted.

Similar to the method 1500, the method 1600 further includes shaping the recessed portion 130c (at FIG. 14F) into the curved cap 70b by heating the recessed portion 130c (Step 1625), bending the recessed portion 130c around a first elongate arcuate surface 380 (Step 1630), and cooling the recessed portion 130c (Step 1635) as the recessed portion 130c is bent around a second elongate arcuate surface 384.

In the illustrated embodiment, the adhesive application stage 308 (Step 1620) and the heating stage 312 (step 1625) are combined. That is, the adhesive 350 is heated and applied to the grooves 158, as described above relative to the machine 300′ for the polygonal cap 70a. The heat from the adhesive 350 is enough to soften the recessed portion 130c of the flooring panel 330. This is possible because a thickness T5 of the flooring panel between the outside 92 and the surfaces of the grooves 158 that receive the adhesive 350 is received is very thin, as discussed above. In some embodiments, the heating stage 312 may be separate from the adhesive stage 308. In this case, the recessed portion 130c may be heated during a separate heating stage 312 after the adhesive 350 is applied. The heating step 312 may be performed by blowing air onto the outside 92 of the floor panel 330 (as discussed above), although any suitable means of applying heat may be used (such as via the use of a radiator).

The machine 300′ further includes a bending stage 316 in which the flooring panel 330 is bent to form the shape of the curved cap 70b (Step 1630). As shown in FIG. 14F, the flooring panel 330 is bent along the recessed portion 130c adjacent to the plurality of grooves 158. The existence of the plurality of grooves 158, which are spaced apart in small increments, allows for the panel 300 to bend continuously to from a curved shape. During the bending stage, the machine 300′ is configured to apply pressure to the recessed portion 130c in the direction of the first elongate arcuate surface 380 using a first set of rollers 388. In some embodiments, bending of the flooring panel 330 is accomplished by moving the flooring panel 330 continuously over a transport length in which the first set of rollers 388 is set closer together over the transport length. As such, the pressure applied to the flooring panel 330 will continue to bend the recessed portion 130c into a tighter radius as the arrangement of the first set of rollers 388 continue to narrow over the transport length. As noted above, the bending stage 316 creates the arcuate surfaces 150, 154 of the curved cap 70b.

Finally, the method includes a cooling stage 320 (Step 1635). With respect to the cooling stage 320, the entire cap 70b may be cooled. In the illustrated embodiment, the second elongate arcuate surface 384 is formed by a tube through which refrigerant flows. The refrigerant thus reduces the temperature of the second arcuate surface 384 to cure the adhesive. The machine 300′ is configured to apply pressure to the recessed portion 130c in the direction of the second elongate arcuate surface 384 using a second set of rollers 392. Applying pressure to the recessed portion 130c allows the flooring panel 330 to have better contact with the second arcuate surface 384 for better cooling. In other embodiments, the cooling step may alternatively be accomplished blowing cooling air having a temperature of than −2 degrees Celsius or less onto the second portion. Other suitable means of applying a cooling temperature may be used. The cooling step cures the adhesive 350. Therefore, the cooling step, in combination with the cured adhesive 350 and the cover member 162, maintains the shape of the curved cap 70b. Once the nose flooring panel 50 is completed it may be guided to a platform 370, where an operator may remove it from the machine 300′. Accordingly, the flooring panel forming machine 300′ moves the flooring panel 330 through the various stages to create the nose flooring panel 50 having a curved cap 70b. In other words, the nose flooring panel 50 is formed using a linear, automated process and without being removed until it has been formed.

### Preassembled Panel Assemblies

The methods 1500, 1600 discussed above describe the manipulation of a single flooring panel 330 to create a single nose flooring panel 50 with either a polygonal cap 70a or a curved cap 70b. In some embodiments, the methods 1500 and/or 1600 may include a joining stage 324 (Step 1503, 1603), which occurs prior to the material removal stage 304. The joining stage 324 may be helpful when joining multiple panels together to form a preassembled nose-tread assembly 250, such as the ones described above. In one embodiment, during the joining stage 324, one or more panels 330 may be coupled to one end to end such that the first end 80 of a first panel 330 is coupled to a second end 84 of a second panel 330. In other words, the panels 300 may be joined together such that multiple panels are used to form a nose flooring panel 50 that extends across the entire width of a stair 14. This enables the machine 300, 300′ to create a pre-assembled nose-tread assembly composed of multiple nose flooring panels 50, for example to create a parquet effect as described above. After two or more flooring panels 330 are joined together, they advanced through the flooring panel forming machine 300, 300′ together to create a nose-tread assembly 250. For example, a first flooring panel 330 may be inserted into an infeed hopper and a second flooring panel 330 may be inserted into the infeed hopper, such that the second flooring panel 330 is positioned adjacent to and contacts the first flooring panel 330.

In some embodiments, the contacting ends 80, 84 of the first flooring panel 330 and the second flooring panel 330 may be positively engaged (e.g., via a tongue and groove arrangement or the like) while in the joining stage 324. Additionally, or alternatively, a securing member (e.g., an elongated strip of tape 400, FIG. 2C) may be coupled to the first and second flooring panels 330 on one or both the inside 88 or outside 92, and over the contacting ends 80, 84 of the first and second panels 330. The coupled flooring panels 330 can then be moved through the remaining stages 304, 308, 312, 316, 320 into the flooring panel forming machine and advanced therethrough to create the cap 70 on the nose-tread assembly 250.

Once completed, the resulting coupled nose-tread assembly 250 can be cut, via a saw or other cutting device, at the cutting stage 328 (Step 1540, 1640) to define a final length of the completed nose-tread assembly 250. The completed nose flooring panel 50 is cut prior to being guided to the platform 370 where it may exit the machine 300, 300′. Using the joining stage 324 (Step 1503, 1603) and the cutting stage 328 (Step 1540, 1640), two or more flooring panels 330 may be inserted into the joining stage 324 and then secured to the adjacent flooring panels 330 via positive engagement with one another and/or using securing members 400 to create a nose-tread assembly 250 having any number of pre-assembled nose flooring panels 50. When the joining stage 324 and the cutting stage 328 are included, the resulting nose-tread assembly 250 can have a parquet effect that is formed linearly using the flooring panel forming machine 300, 300′.

Once the nose flooring panel 50 or nose-tread assembly 250 is/are formed (using the methods above), it/they can be assembled with and secured relative to one or more intermediate tread flooring panels 54b or one or more tread flooring panels 54a to create the pre-assembled nose-tread assembly 250, as discussed above. Either of the methods thus includes mechanically coupling the first coupling edge 104 of the nose flooring panel(s) 50 opposite polygonal or curved cap 70b to the second edge(s) 220a, 220b of a tread flooring panel 54a, 54b. Then, the method includes coupling the first securing member 260, 264 to the inside 88, 208a, 208b of each of the nose flooring panel 50 and the tread flooring panel 54a, 54b over the coupled edges 104, 220, 228. Then, the method may include coupling the first securing members 268, 272 to the outsides 92, 212a, 212b of each of the nose flooring panel 50 and the tread flooring panel 54a, 54b over the coupled edges 104, 220228.

Various features of the invention are set forth in the following claims.

What is claimed is:

1. A flooring panel comprising:
a first end, a second end opposite the first end, and an axis extending between the first end and the second end;
a tread portion extending between the first and second ends, the tread portion configured to be coupled to a tread of a stair;
a curved cap integrally formed with the tread portion and extending between the first end and the second end, the curved cap configured to be coupled to an edge of the stair;
a plurality of grooves formed in an inner surface of the curved cap, the plurality of grooves extending parallel to the axis of the tread portion, the plurality of grooves extending along a majority of inner surface of the curved cap; and
a cover member adhesively coupled to the inner surface and covering the plurality of grooves.

2. The flooring panel of claim 1, wherein the cover member is formed from paper or foil.

3. The flooring panel of claim 1, wherein the tread portion includes a coupling edge opposite the curved cap, and further comprising a tread flooring panel coupled to the coupling edge of the tread portion to form a pre-assembled nose-tread assembly, the nose-tread assembly configured to be installed on a stair as a single unit.

4. The flooring panel of claim 3, further comprising a securing member extending along at least a portion of the coupling edge to secure the tread flooring panel to the coupling edge of the tread portion.

5. The flooring panel of claim 4, wherein the securing member is a first securing member, the first securing member positioned on an inside surface of the tread portion, and further comprising a second securing member positioned on an outside surface of the tread portion.

6. The flooring panel of claim 5, wherein the second securing member includes a no-residue adhesive to allow the second securing member to be removed from the flooring panel without leaving residue.

7. The flooring panel of claim 1, wherein at least one of the first end and the second end is configured to abut or couple with an end of another flooring panel having a curved cap.

8. The flooring panel of claim 1, wherein the curved cap has a thickness and wherein a depth of each of the plurality of grooves is greater than 50% of the thickness.

9. The flooring panel of claim 8, wherein the thickness of the curved cap is less than a thickness of the tread portion.

10. The flooring panel of claim 1, wherein the plurality of grooves includes at least ten grooves.

11. A method of manufacturing a nose flooring panel, the method comprising:
providing a flooring panel having a first end, a second end opposite the first end, and an axis extending between the first end and the second end;
supporting a first portion of the flooring panel on a flooring panel forming machine, the forming machine configured to move the flooring panel along an imaginary plane extending from a first end to a second end of the forming machine;
cutting a plurality of grooves in a second portion of the flooring panel, the plurality of grooves extending parallel to the axis;
applying adhesive to the plurality of grooves;
heating the second portion of the flooring panel;
bending the second portion of the flooring panel into a cap while maintaining the flat shape of the first portion of the flooring panel to form a tread; and
cooling the second portion to cure the adhesive.

12. The method of claim 11, wherein bending the second portion includes bending the second portion of the flooring panel into an arcuate shape such that the cap has a circular cross-section.

13. The method of claim 11, wherein heating the second portion of the flooring panel is accomplished by heating the adhesive and allowing heat from the adhesive to heat the second portion.

14. The method of claim 11, further comprising applying a cover member to the flooring panel over the plurality of groves prior to bending the second portion.

15. The method of claim 11, further comprising forming a recessed section in the second portion of the flooring panel such that first portion has a first thickness and the second portion has a second thickness that is less than the first thickness, and wherein cutting the plurality of grooves includes cutting the plurality of grooves within the recessed section.

16. The method of claim 15, further comprising joining a plurality of flooring panels together prior to forming the recessed section such that the recessed section and the plurality of grooves are formed within the plurality of flooring panels.

17. The method of claim 16, further comprising cutting the flooring panel to a final length after cooling the second portion.

18. The method of claim 15, wherein the recessed section is a first recessed section and the plurality of grooves is a first plurality of grooves; and
further comprising forming a second recessed section in a second portion of the flooring panel and cutting a second plurality of grooves in the second recessed section of the flooring panel, the second plurality of grooves extending parallel to the axis,
wherein a first segment of the flooring panel is defined between the first plurality of grooves and the second plurality of grooves and a second segment of the flooring panel is defined between the second plurality of grooves and the second end.

19. The method of claim 18, wherein bending the second portion includes bending the second portion of the flooring panel such that the cap is a polygonal cap.

20. A flooring panel forming machine for making nose flooring panels having a first portion forming a tread of the flooring panel and a second portion forming a cap of the flooring panel, the machine comprising:
a material removal stage configured to cut a plurality of grooves within the second portion of the flooring panel, the plurality of grooves extending parallel to one another from a first end to a second end of the flooring panel;
a heating stage configured to melt an adhesive and apply the melted adhesive to the plurality of grooves;
a bending stage configured to form the second portion of the flooring panel into a cap while maintaining the flat shape of the first portion of the flooring panel to form a tread; and
a cooling stage configured to cool the second portion of the flooring panel to cure the adhesive,
wherein the machine includes a conveyor system configured to continuously move the flooring panel through the stages of the machine to form a nose flooring panel.

21. The machine of claim 20, further comprising a cover member application stage configured to place a cover member onto the second portion to cover the plurality of grooves, the cover member being adhered to the second portion by the adhesive.

22. The machine of claim 20, wherein, prior to cutting the plurality of grooves, the material removal stage is further configured to form a recessed section in the second portion of the flooring panel, and wherein the plurality of grooves is cut into the recessed section.

23. The machine of claim 22, wherein the material removal stage includes one or more cutting blades configured to form one or both the recessed section or the plurality of grooves.

24. The machine of claim 20, wherein the bending stage includes a first elongate arcuate surface and a first set of rollers, wherein the first set of rollers is configured to apply pressure to the second portion of the flooring panel toward the first elongate arcuate surface to bend the flooring panel into a curved cap.

25. The machine of claim 20, wherein the cooling stage includes a tube through which refrigerant flows, the tube and refrigerate configured to absorb heat from the flooring panel.

26. The machine of claim 25, wherein the cooling stage further includes a set of rollers configured to apply pressure to the second portion of the flooring panel toward the tube to increase contact between the flooring panel and the tube for cooling.

27. A flooring panel comprising:
a first end, a second end opposite the first end, and an axis extending between the first end and the second end;
a tread portion extending between the first and second ends, the tread portion configured to be coupled to a tread of a stair;
a polygonal cap integrally formed with the tread portion and extending between the first end and the second end, the polygonal cap configured to be coupled to an edge of the stair, the polygonal cap including:
a first wall extending from the tread portion;
a second wall extending from the first wall;
a first corner positioned between the tread portion and the first wall, the first corner including a first plurality of grooves extending parallel to the axis of the tread portion between the first end and the second end; and
a second corner extending between the first wall and the second wall, the second corner including a second plurality of grooves parallel to the axis of the tread portion between the first end and the second end.

28. The flooring panel of claim 27, wherein the first wall is spaced apart from the first tread portion by a first gap and the second wall is spaced apart from the first wall by second gap.

29. The flooring panel of claim 27, further comprising an adhesive positioned within the first plurality of grooves and the second plurality of grooves, the adhesive configured to maintain a position of the first wall relative to the tread portion and the second wall relative to the first wall.

30. The flooring panel of claim 27, wherein an inner surface of the polygonal cap is recessed relative to inner surfaces of the tread portion, the first wall, and the second wall.

31. The flooring panel of claim 27, wherein the tread portion includes a coupling edge opposite the curved cap, and further comprising a tread flooring panel coupled to the coupling edge of the tread portion to form a pre-assembled nose-tread assembly, the nose-tread assembly configured to be installed on a stair as a single unit.

32. The flooring panel of claim 31, further comprising a securing member extending along at least a portion of the coupling edge to secure the tread flooring panel to the coupling edge of the tread portion.

33. The flooring panel of claim 32, wherein the securing member is a first securing member, the first securing member positioned on an inside surface of the tread portion, and further comprising a second securing member positioned on an outside surface of the tread portion.

34. The flooring panel of claim 33, wherein the second securing member includes a no-residue adhesive to allow the second securing member to be removed from the flooring panel without leaving residue.

35. The flooring panel of claim 34, wherein at least one of the first end and the second end is configured to abut or couple with an end of another flooring panel having a curved cap.
